(19) United States
(12) Patent Application Publication
(10) Pub. No.: US 2017/0082055 A1
(43) Pub. Date: Mar. 23, 2017

(54) System and Method for Estimating an Engine Operating Parameter Using a Physics-Based Model and Adjusting the Estimated Engine Operating Parameter Using an Experimental Model

(71) Applicant: GM Global Technology Operations LLC, Detroit, MI (US)

(72) Inventors: Gary Robert CYGAN, JR., Auburn Hills, MI (US); Ning Jin, Novi, MI (US)

(21) Appl. No.: 14/857,250

(22) Filed: Sep. 17, 2015

(51) Int. Cl. F02D 41/24; F02D 41/26; F02D 41/10; F02D 41/30; G07C 5/08; F02D 41/00

(52) U.S. Cl. CPC F02D 41/2425; G07C 5/0808; F02D 41/0002; F02D 41/10; F02D 41/3005; F02D 41/26

(57) ABSTRACT

A system according to the present disclosure includes an engine parameter estimation module, an error magnitude module, an engine parameter adjustment module, and an engine actuator control module. The engine parameter estimation module estimates an engine operating parameter using a physics-based model. The error magnitude module determines a magnitude of error between the estimated engine operating parameter and an actual value of the engine operating parameter using an experimental model. The engine parameter adjustment module adjusts the estimated engine operating parameter based on the error magnitude. The engine actuator control module controls an actuator of the engine based on the estimated engine operating parameter as adjusted.

### FIELD

The present disclosure relates to internal combustion engines, and more particularly, to systems and methods for estimating an engine operating parameter using a physics-based model and adjusting the estimated engine operating parameter using an experimental model.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Engine control systems estimate various operating parameters of an engine and control various actuators of the engine based on the estimated engine operating parameters. For example, an engine control system may estimate an amount of air in each cylinder of an engine, and control a throttle valve, a fuel injector, and a spark plug based on the estimated air per cylinder. Thus, inaccuracies in the estimated engine operating parameters may cause engine control systems to control engine actuators less accurately than desired.

Engine control systems typically estimate engine operating parameters using either a physics-based model or an experimental model. The complexity of a physics-based model is limited by the processing power of an engine control system. Thus, estimating engine operating parameters using a physics-based model may not yield a desired degree of accuracy. Estimating the engine operating parameter using an experimental model may require a significant amount of calibration work in order to develop an experimental model that achieves a desired degree of accuracy.

### SUMMARY

A system according to the present disclosure includes an engine parameter estimation module, an error magnitude module, an engine parameter adjustment module, and an engine actuator control module. The engine parameter estimation module estimates an engine operating parameter using a physics-based model. The error magnitude module determines a magnitude of error between the estimated engine operating parameter and an actual value of the engine operating parameter using an experimental model. The engine parameter adjustment module adjusts the estimated engine operating parameter based on the error magnitude. The engine actuator control module controls an actuator of the engine based on the estimated engine operating parameter as adjusted.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system according to the principles of the present disclosure;

FIG. 2 is a functional block diagram of an example control system according to the principles of the present disclosure; and

FIG. 3 is a flowchart illustrating an example control method according to the principles of the present disclosure.

In the drawings, reference numbers may be reused to identify similar and/or identical elements.

### DETAILED DESCRIPTION

A system and method according to the present disclosure estimates an engine operating parameter using a physics-based model and adjusts the estimated engine operating parameter using an experimental model. In one example, the system and method estimates an amount of air in each cylinder of an engine using a physics-based model and adjusts the estimated air per cylinder using an experimental model. The system and method then controls an actuator of the engine, such as a throttle valve, based on the estimated engine operating parameter as adjusted. Estimating and adjusting the engine operating parameter in the manner described above decreases the amount of calibration work required to develop the experimental model while ensuring that the engine operating parameter is estimated as accurately as desired.

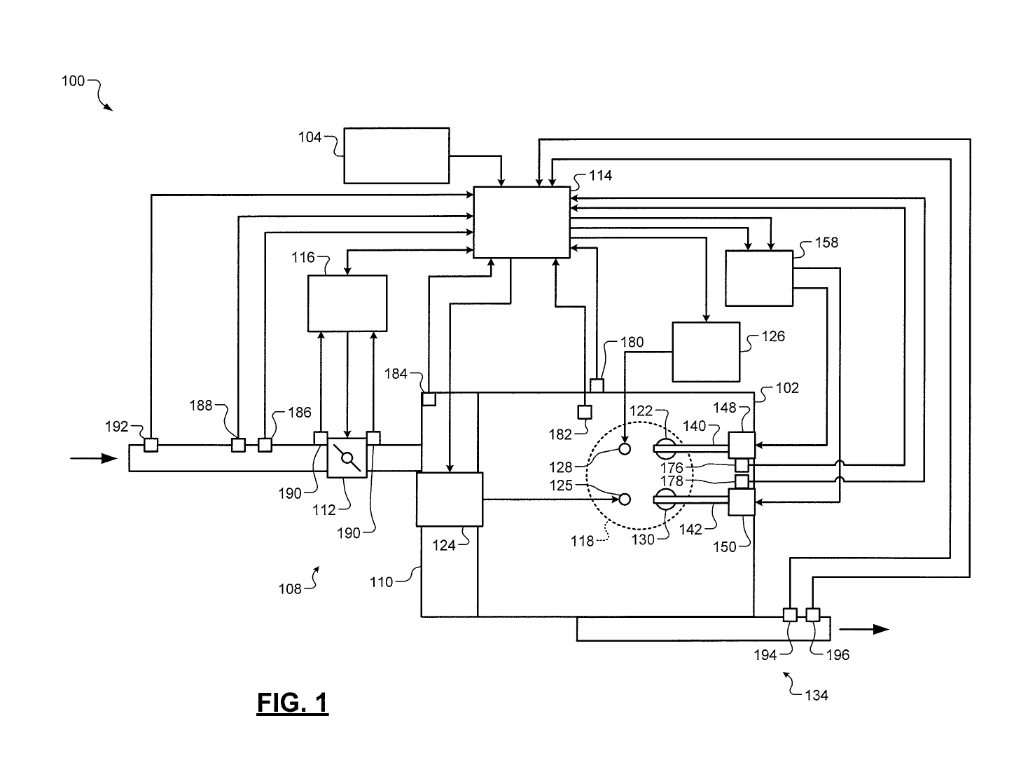

Referring now to FIG. 1, an engine system 100 includes an engine 102 that combusts an air/fuel mixture to produce drive torque for a vehicle. The amount of drive torque produced by the engine 102 is based on a driver input from a driver input module 104. The driver input may be based on a position of an accelerator pedal. The driver input may also be based on a cruise control system, which may be an adaptive cruise control system that varies vehicle speed to maintain a predetermined following distance.

Air is drawn into the engine 102 through an intake system 108. The intake system 108 includes an intake manifold 110 and a throttle valve 112. The throttle valve 112 may include a butterfly valve having a rotatable blade. An engine control module (ECM) 114 controls a throttle actuator module 116, which regulates opening of the throttle valve 112 to control the amount of air drawn into the intake manifold 110.

Air from the intake manifold 110 is drawn into cylinders of the engine 102. While the engine 102 may include multiple cylinders, for illustration purposes a single representative cylinder 118 is shown. For example only, the engine 102 may include 2, 3, 4, 5, 6, 8, 10, and/or 12 cylinders. The ECM 114 may deactivate some of the cylinders, which may improve fuel economy under certain engine operating conditions.

The engine 102 may operate using a four-stroke cycle. The four strokes, described below, are named the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes.

During the intake stroke, air from the intake manifold 110 is drawn into the cylinder 118 through an intake valve 122. The ECM 114 controls a fuel actuator module 124, which regulates fuel injections performed by a fuel injector 125 to achieve a desired air/fuel ratio. Fuel may be injected into the intake manifold 110 at a central location or at multiple locations, such as near the intake valve 122 of each of the cylinders. In various implementations, fuel may be injected directly into the cylinders or into mixing chambers associated with the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. The engine 102 may be a compression-ignition engine, in which case compression in the cylinder 118 ignites the air/fuel mixture. Alternatively, the engine 102 may be a spark-ignition engine, in which case a spark actuator module 126 energizes a spark plug 128 to generate a spark in the cylinder 118 based on a signal from the ECM 114, which ignites the air/fuel mixture. The timing of the spark may be specified relative to the time when the piston is at its topmost position, referred to as top dead center (TDC).

The spark actuator module 126 may be controlled by a spark timing signal specifying how far before or after TDC to generate the spark. Because piston position is directly related to crankshaft rotation, operation of the spark actuator module 126 may be synchronized with crankshaft angle. In various implementations, the spark actuator module 126 may halt provision of spark to deactivated cylinders.

Generating the spark may be referred to as a firing event. The spark actuator module 126 may have the ability to vary the timing of the spark for each firing event. The spark actuator module 126 may even be capable of varying the spark timing for a next firing event when the spark timing signal is changed between a last firing event and the next firing event. In various implementations, the engine 102 may include multiple cylinders and the spark actuator module 126 may vary the spark timing relative to TDC by the same amount for all cylinders in the engine 102.

During the combustion stroke, combustion of the air/fuel mixture drives the piston down, thereby driving the crankshaft. The combustion stroke may be defined as the time between the piston reaching TDC and the time at which the piston returns to bottom dead center (BDC). During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118).

The time at which the intake valve 122 is opened may be varied with respect to piston TDC by an intake cam phaser 148. The time at which the exhaust valve 130 is opened may be varied with respect to piston TDC by an exhaust cam phaser 150. A valve actuator module 158 may control the intake and exhaust cam phasers 148, 150 based on signals from the ECM 114. When implemented, variable valve lift may also be controlled by the valve actuator module 158.

The ECM 114 may deactivate the cylinder 118 by instructing the valve actuator module 158 to disable opening of the intake valve 122 and/or the exhaust valve 130. The valve actuator module 158 may disable opening of the intake valve 122 by decoupling the intake valve 122 from the intake camshaft 140. Similarly, the valve actuator module 158 may disable opening of the exhaust valve 130 by decoupling the exhaust valve 130 from the exhaust camshaft 142. In various implementations, the valve actuator module 158 may control the intake valve 122 and/or the exhaust valve 130 using devices other than camshafts, such as electromagnetic or electrohydraulic actuators.

The engine system 100 may measure the position of the intake cam phaser 148 using an intake cam phaser position (ICAM) sensor 176. The position of the exhaust cam phaser 150 may be measured using an exhaust cam phaser position (ECAM) sensor 178. The position of the crankshaft using a crankshaft position (CKP) sensor 180. The temperature of the engine coolant may be measured using an engine coolant temperature (ECT) sensor 182. The ECT sensor 182 may be located within the engine 102 or at other locations where the coolant is circulated, such as a radiator (not shown).

The pressure within the intake manifold 110 may be measured using a manifold absolute pressure (MAP) sensor 184. In various implementations, engine vacuum, which is the difference between ambient air pressure and the pressure within the intake manifold 110, may be measured. The mass flow rate of air flowing into the intake manifold 110 may be measured using a mass air flow (MAF) sensor 186. The MAF sensor 186 may be located in a housing that also includes the throttle valve 112. The pressure of air at an inlet of the throttle valve 112 may be measured using a throttle inlet air pressure (TIAP) sensor 188.

The throttle actuator module 116 may monitor the position of the throttle valve 112 using one or more throttle position sensors (TPS) 190. The ambient temperature of air being drawn into the engine 102 may be measured using an intake air temperature (IAT) sensor 192. The temperature of exhaust gas expelled from the engine 102 may be measured using an exhaust gas temperature (EGT) sensor 194. The pressure of exhaust gas expelled from the engine 102 may be measured using an exhaust gas pressure (EGP) sensor 196.

The ECM 114 uses signals from the sensors to make control decisions for the engine system 100. In one example, the ECM 114 estimates an engine operating parameter based on the signals using a physics-based model. The engine operating parameter may be the amount of air delivered to each cylinder of the engine 102, referred to as air per cylinder. The ECM 114 then determines a magnitude of error between the estimated engine operating parameter and an actual value of the engine operating parameter based on the signals using an experimental model. The ECM 114 then adjusts the estimated engine operating parameter based on the error magnitude, and controls the torque output of the engine 102 based on the estimated engine operating parameter as adjusted.

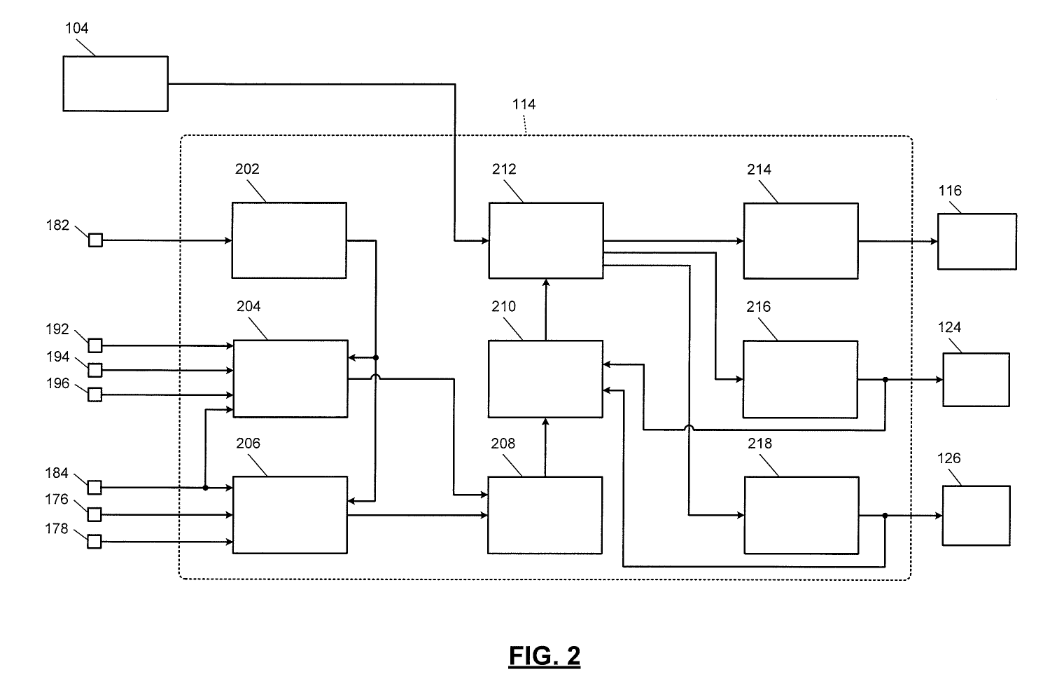

Referring now to FIG. 2, the ECM 114 includes an engine speed module 202, an engine parameter estimation module 204, an error magnitude module 206, and an engine parameter adjustment module 208. The engine speed module 202 determines the speed of the engine 102 based on the crankshaft position from the CKP sensor 180. For example, the engine speed module 202 may calculate the engine speed (or crankshaft speed) based on a period that elapses as the crankshaft completes one or more revolutions. The engine speed module 202 outputs the engine speed.

The engine parameter estimation module 204 estimates an operating parameter of the engine 102 using a physics-based model. For example, the engine parameter estimation module 204 may estimate an amount of air in each cylinder of the engine 102, a torque output of the engine 102, or an air/fuel ratio of the engine 102 using a physics-based model. The engine parameter estimation module 204 outputs the estimated engine operating parameter.

The engine parameter estimation module 204 may estimate the amount of air trapped in each cylinder of the engine 102 when an intake valve of each cylinder is closed at the end of their respective intake strokes, referred to as the air per cylinder. The engine parameter estimation module 204 may estimate the air per cylinder using a relationship based on the ideal gas law such as

$${m}_{c} = \frac{{M}_{a} {P}_{c} {V}_{c}}{{RT}_{c}} \qquad ( 1 )$$

where m_{c} is the mass of air per cylinder, Mₐ is the molar mass of air, P_{c} is the pressure in each cylinder at the end of their respective intake stroke, V_{c} is the volume in each cylinder at the end of their respective intake stroke, R is the universal gas constant, and T_{c} is the temperature of air in each cylinder at the end of their respective intake stroke.

The engine parameter estimation module 204 may estimate the volume in each cylinder for a given crank angle using a relationship such as

$${V}_{c} = \frac{1}{4} π {B}^{2} [ r \cdot ( 1 - cos ( ω t ) ) + l - \sqrt{{l}^{2} - {r}^{2} {sin}^{2} ( ω t )} ] + \frac{{V}_{d}}{( r - 1 )} \qquad ( 2 )$$

where B is the cylinder bore diameter, ω is the crankshaft speed, t is time, l is the connecting rod length, r is the crank radius (or one-half of the piston stroke), and V_{d} is the displacement volume of the cylinder. The time t is relative to a predetermined starting time, and the product of the time t and the crankshaft speed yields the crank angle for which the cylinder volume is determined using relationship (2).

The engine parameter estimation module 204 may estimate the pressure in each cylinder using a relationship based on the law of conservation of mass such as

\dot{m}_{c}=\dot{m}ₑ+\dot{m}i (3)

where \dot{m}ₑ is the rate of air mass change in the cylinder, \dot{m}ₑ is the mass flow rate of air through the exhaust valve of the cylinder, and al; is the mass flow rate of air through the intake valve of the cylinder.

The engine parameter estimation module 204 may estimate the rate of air mass change in the cylinder by combining relationships (1) and (2), and differentiating the mass of air per cylinder with respect to time to yield a relationship such as

$${\dot{m}}_{c} = \frac{1}{{RT}_{c}} \{ [ \frac{1}{4} π {B}^{2} [ r \cdot ( 1 - cos ( ω t ) ) + l - \sqrt{{l}^{2} - {r}^{2} {sin}^{2} ( ω t )} ] + \frac{{V}_{d}}{( r - 1 )} ] \frac{d ( {P}_{c} )}{d t} + [ \frac{1}{4} π {B}^{2} r ω \cdot sin ( ω t ) ( 1 + \frac{r cos ( ω t )}{\sqrt{{l}^{2} - {r}^{2} {sin}^{2} ( ω t )}} ) ] {P}_{c} \} \qquad ( 4 )$$

The engine parameter estimation module 204 may estimate the mass flow rate of air through the exhaust valve of the cylinder using a relationship such as

$${\dot{m}}_{e} = sgn ( {P}_{e} - {P}_{c} ) \sqrt{\frac{2 γ}{γ - 1} \{ {[ \frac{min ( {P}_{e} , {P}_{c} )}{max ( {P}_{e} , {P}_{c} )} ]}^{\frac{2}{γ}} - {[ \frac{min ( {P}_{e} , {P}_{c} )}{max ( {P}_{e} , {P}_{c} )} ]}^{\frac{γ + 1}{γ}} \}} ( \sqrt{\frac{1}{{RT}_{e}}} ) {c}_{p} {A}_{e} max ( {P}_{e} , {P}_{c} ) \qquad ( 5 )$$

where sgn( ) is the signum function, Pₑ is the exhaust port pressure, γ is the ratio of specific heats for air, Tₑ is the exhaust port temperature, cₚ is the specific heat of air, and Aₑ is the area of the exhaust port. The exhaust gas temperature and the exhaust gas pressure from the EGT sensor 194 and the EGP sensor 196, respectively, may be used as approximations of the exhaust port pressure and the exhaust port temperature, respectively.

The engine parameter estimation module 204 may estimate the mass flow rate of air through the intake valve of the cylinder using a relationship such as

$${\dot{m}}_{l} = sgn ( {P}_{i} - {P}_{c} ) \sqrt{\frac{2 γ}{γ - 1} \{ {[ \frac{min ( {P}_{i} , {P}_{c} )}{max ( {P}_{i} , {P}_{c} )} ]}^{\frac{2}{γ}} - {[ \frac{min ( {P}_{i} , {P}_{c} )}{max ( {P}_{i} , {P}_{c} )} ]}^{\frac{γ + 1}{γ}} \}} ( \sqrt{\frac{1}{{RT}_{c}}} ) {c}_{p} {A}_{i} max ( {P}_{i} , {P}_{c} ) \qquad ( 6 )$$

where Pᵢ is the intake port pressure, Tᵢ is the intake port temperature, and Aᵢ is the area of the intake port. The manifold pressure and the intake air temperature from the MAP sensor 184 and the IAT sensor 192, respectively, may be used as approximations of the intake port pressure and the intake port temperature, respectively. Relationships (5) and (6) are based on the Navier-Stokes equations.

The engine parameter estimation module 204 may insert relationships (4), (5), and (6) into relationship (3) to obtain the following relationship

$$\{ [ \frac{1}{4} π {B}^{2} \frac{1}{{RT}_{c}} [ r \cdot ( 1 - cos ( ω t ) ) + l - \sqrt{{l}^{2} - {r}^{2} {sin}^{2} ( ω t )} ] + \frac{{V}_{d}}{( r - 1 )} \frac{1}{{RT}_{c}} ] \frac{d ( {P}_{c} )}{d t} + [ \frac{1}{4} π {B}^{2} r ω \cdot sin ( ω t ) ( 1 + \frac{r cos ( ω t )}{\sqrt{{l}^{2} - {r}^{2} {sin}^{2} ( ω t )}} ) ] {P}_{c} \} = sgn ( {P}_{e} - {P}_{c} ) \sqrt{\frac{2 γ}{γ - 1} \{ {[ \frac{min ( {P}_{e} , {P}_{c} )}{max ( {P}_{e} , {P}_{c} )} ]}^{\frac{2}{γ}} - {[ \frac{min ( {P}_{e} , {P}_{c} )}{max ( {P}_{e} , {P}_{c} )} ]}^{\frac{γ + 1}{γ}} \}} ( \sqrt{\frac{1}{{RT}_{e}}} ) {c}_{p} {A}_{e} max ( {P}_{e} , {P}_{c} ) + sgn ( {P}_{i} - {P}_{c} ) \sqrt{\frac{2 γ}{γ - 1} \{ {[ \frac{min ( {P}_{i} , {P}_{c} )}{max ( {P}_{i} , {P}_{c} )} ]}^{\frac{2}{γ}} - {[ \frac{min ( {P}_{i} , {P}_{c} )}{max ( {P}_{i} , {P}_{c} )} ]}^{\frac{γ + 1}{γ}} \}} ( \sqrt{\frac{1}{{RT}_{c}}} ) {c}_{p} {A}_{i} max ( {P}_{i} , {P}_{c} ) \qquad ( 7 )$$

The engine parameter estimation module 204 may estimate the cylinder pressure at any given crank angle represented by (ωt) using relationship (7).

The engine parameter estimation module 204 may estimate the temperature of air in each cylinder and the end of its intake stroke using a relationship such as

$${T}_{c} = \frac{1}{1 - ( 1 - \frac{{T}_{i}}{{T}_{e}} ) \frac{{P}_{e} 1}{{P}_{i} γ}} {T}_{i} \qquad ( 8 )$$

Relationship (8) is based on the ideal gas law and the laws of conservation of energy and mass.

Thus, the engine parameter estimation module 204 may determine the volume, pressure, and temperature of a cylinder at the end of its intake stroke using relationships (4), (7), and (8), respectively. The engine parameter estimation module 204 may then insert these values into relationship (1) to estimate the amount of air trapped in the cylinder at the end of its intake stoke. Alternatively, relationships (1), (4), (7), and (8) may be combined, and the engine parameter estimation module 204 may use the combined relationship to estimate the air per cylinder.

The error magnitude module 206 determines a magnitude (e.g., percentage) of error between the estimated engine operating parameter and an actual value of the engine operating parameter using an experimental model. The experimental model may be developed experimentally through calibration work performed in a laboratory or using a specially instrumented vehicle on a road. For example, the vehicle may include instrumentation that measures the engine operating parameter which is not normally present on a production vehicle. The experimental model may be developed independent of physical laws such as the ideal gas law and the laws of conservation of mass and energy. The error magnitude module 206 outputs the error magnitude.

In one example, the error magnitude module 206 may determine the magnitude of error between the estimated air per cylinder and an actual value of the air per cylinder using an experimental model. The error magnitude module 206 may determine the error magnitude of the estimated air per cylinder based on the engine speed, the manifold pressure, the intake cam position of the respective cylinder, and the exhaust cam position of the respective cylinder. The error magnitude module 206 may receive the engine speed, the manifold pressure, the intake cam phaser position, and the exhaust cam phaser position from the engine speed module 202, the MAP sensor 184, the ICAM sensor 176, and the ECAM sensor 178, respectively.

The engine parameter adjustment module 208 adjusts the estimated engine operating parameter based on the error magnitude. For example, the engine parameter adjustment module 208 may set an error correction factor to an amount that is equal in magnitude and opposite in sign relative to the error magnitude, and adjust the estimated engine operating parameter based on the error correction factor. The engine parameter adjustment module 208 may adjust the estimated engine operating parameter based on the error correction factor by adding the error correction factor to the estimated engine operating parameter. The engine parameter adjustment module 208 outputs the estimated engine operating parameter as adjusted.

The example implementation of the ECM 114 shown in FIG. 2 further includes a torque estimation module 210, and a torque request module 212, a throttle control module 214, a fuel control module 216, and a spark control module 218. The torque estimation module 210 estimates the torque output of the engine 102 based on the estimated engine operating parameter as adjusted. For example, the torque estimation module 210 may estimate the engine torque output based on the estimated amount of air per cylinder, a commanded fueling amount per cylinder, and a commanded spark timing per cylinder using a predetermined relationship. The predetermined relationship may be embodied in a lookup table and/or an equation. The torque estimation module 210 may receive the commanded fueling amount and the commanded spark timing from the fuel control module 216 and the spark control module 218, respectively. The torque estimation module 210 outputs the estimated torque output of the engine 102.

The torque request module 212 determines a torque request based on the driver input from the driver input module 104. For example, the torque request module 212 may store one or more mappings of accelerator pedal position to desired torque and determine the torque request based on a selected one of the mappings. The torque request module 212 may select one of the mappings based on the engine speed and/or vehicle speed.

The torque request module 212 may adjust the torque request based on the estimated torque output of the engine 102. For example, the torque request module 212 may adjust the torque request to minimize a difference between the unadjusted torque request and the estimated torque output of the engine 102. The torque request module 212 outputs the torque request as adjusted.

The throttle control module 214 controls the throttle valve 112 by instructing the throttle actuator module 116 to achieve a desired throttle area. The fuel control module 216 controls the fuel injector 125 by instructing the fuel actuator module 124 to achieve a desired pulse width. The spark control module 218 controls the spark plug 128 by instructing the spark actuator module 126 to achieve desired spark timing. The throttle valve 112, the fuel injector 125, and the spark plug 128 may be referred to as engine actuators, and the throttle control module 214, the fuel control module 216, and the spark control module 218 may be referred to as engine actuator control modules.

The throttle control module 214 and the spark control module 218 may adjust the desired throttle area and the desired spark timing, respectively, based on the torque request. The throttle control module 214 may increase or decrease the desired throttle area when the torque request increases or decreases, respectively. The spark control module 218 may advance or retard the spark timing when the torque request increases or decreases, respectively.

The fuel control module 216 may adjust the desired pulse width to achieve a desired air/fuel ratio such as a stoichiometric air/fuel ratio. For example, the fuel control module 216 may adjust the desired pulse width to minimize a difference between an actual air/fuel ratio and the desired air/fuel ratio. Controlling the air/fuel ratio in this way may be referred to as closed-loop control of the air/fuel ratio.

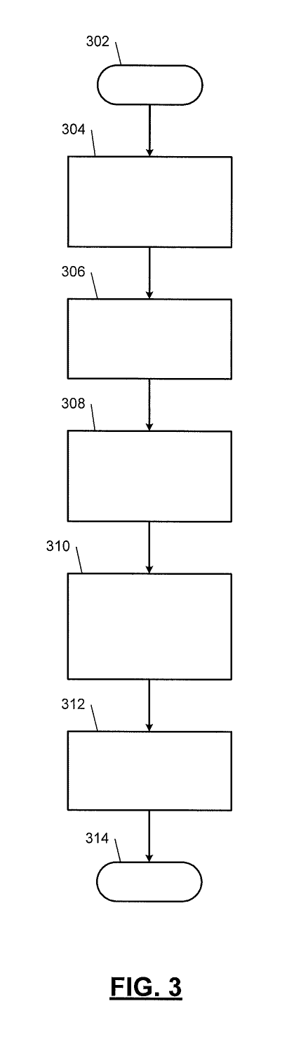

Referring now to FIG. 3, an example method for estimating an engine operating parameter using a physics-based model and adjusting the estimated engine operating parameter using an experimental model begins at 302. The method of FIG. 3 is described in the context of the modules included in the example implementation of the ECM 114 shown in FIG. 2. However, the particular modules that perform the steps of the method of FIG. 3 may be different than the modules mentioned below and/or the method of FIG. 3 may be implemented apart from the modules of FIG. 3.

At 304, the engine parameter estimation module 204 estimates an operating parameter of the engine 102 using a physics-based model. For example, the engine parameter estimation module 204 may estimate the amount of air in each cylinder of the engine 102, the torque output of the engine 102, or the air/fuel ratio of the engine 102 using a physics-based model. The engine parameter estimation module 204 may estimate the air per cylinder using relationships (1) through (8) discussed above.

At 306, the error magnitude module 206 a magnitude (e.g., percentage) of error between the estimated engine operating parameter and an actual value of the engine operating parameter using an experimental model. The experimental model is developed experimentally through calibration work performed in a laboratory or using a specially instrumented vehicle on a road. The experimental model may be developed independent of physical laws such as the ideal gas law and the laws of conservation of mass and energy.

At 308, the engine parameter adjustment module 208 adjusts the estimated engine operating parameter based on the error magnitude. For example, the engine parameter adjustment module 208 may adjust the estimated engine operating parameter by an amount that is equal in magnitude and opposite in sign relative to the error magnitude.

At 310, the torque request module 212 determines a torque request based on the estimated engine operating parameter as adjusted. For example, the torque request module 212 may determine the torque request based on the driver input from the driver input module 104 and adjust the torque request based on the estimated engine operating parameter as adjusted. As discussed above, the estimated engine operating parameter may be an estimated torque output of the engine 102. Alternatively, the estimated engine operating parameter may be an estimated air per cylinder, and the torque estimation module 210 may estimate the torque output of the engine 102 based on the estimated air per cylinder as adjusted. In either case, the torque request module 212 may adjust the torque request based on the estimated torque output to minimize a difference between the unadjusted torque request and the estimated torque output of the engine 102.

At 312, an engine actuator control module controls an engine actuator based on the torque request. For example, the throttle control module 214, the fuel control module 216, and the spark control module 218 may control the throttle valve 112, the fuel injector 125, and the spark plug 128, respectively, based on the torque request. At 314, the method ends.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A OR B OR C), using a non-exclusive logical OR, and should not be construed to mean “at least one of A, at least one of B, and at least one of C.” It should be understood that one or more steps within a method may be executed in different order (or concurrently) without altering the principles of the present disclosure.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Pert, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A system comprising:
an engine parameter estimation module that estimates an engine operating parameter using a physics-based model;
an error magnitude module that determines a magnitude of error between the estimated engine operating parameter and an actual value of the engine operating parameter using an experimental model;
an engine parameter adjustment module that adjusts the estimated engine operating parameter based on the error magnitude; and
an engine actuator control module that controls an actuator of the engine based on the estimated engine operating parameter as adjusted.

2. The system of claim 1 wherein the engine parameter adjustment module:
determines an error correction factor based on the error magnitude; and
adjusts the estimated engine operating parameter based on the error correction factor.

3. The system of claim 2 wherein the engine operating parameter includes at least one of an amount of air in a cylinder of an engine, a torque output of the engine, and an air/fuel ratio of the engine.

4. The system of claim 3 wherein the engine operating parameter includes the amount of air trapped in the cylinder when an intake valve of the cylinder is closed.

5. The system of claim 4 wherein the engine parameter estimation module estimates the amount of air in the cylinder based on a pressure in the cylinder, a volume of the cylinder, and a temperature of air in the cylinder using the physics-based model.

6. The system of claim 5 wherein the engine parameter estimation module estimates the pressure in the cylinder and the temperature of air in the cylinder based on an intake air temperature, an intake manifold pressure, an exhaust gas temperature, an exhaust gas pressure, and engine speed.

7. The system of claim 6 wherein the error magnitude module determines the error magnitude based on an intake cam phaser position and an exhaust cam phaser position using the experimental model.

8. The system of claim 7 wherein the error magnitude module determines the error magnitude further based on the intake manifold pressure and the engine speed using the experimental model.

9. The system of claim 4 further comprising a torque estimation module that estimates the torque output of the engine based on the estimated amount of air in the cylinder as adjusted, wherein the engine actuator control module controls the engine actuator based on the estimated torque output.

10. The system of claim 9 further comprising a torque request module that determines a torque request based on the estimated torque output and a driver torque request, wherein the engine actuator control module controls the engine actuator based on the torque request.

11. A method comprising:
estimating an engine operating parameter using a physics-based model;
determining a magnitude of error between the estimated engine operating parameter and an actual value of the engine operating parameter using an experimental model;
adjusting the estimated engine operating parameter based on the error magnitude; and
controlling an actuator of the engine based on the estimated engine operating parameter as adjusted.

12. The method of claim 11 further comprising:
determines an error correction factor based on the error magnitude; and
adjusts the estimated engine operating parameter based on the error correction factor.

13. The method of claim 12 wherein the engine operating parameter includes at least one of an amount of air in a cylinder of an engine, a torque output of the engine, and an air/fuel ratio of the engine.

14. The method of claim 13 wherein the engine operating parameter includes the amount of air trapped in the cylinder when an intake valve of the cylinder is closed.

15. The method of claim 14 further comprising estimating the amount of air in the cylinder based on a pressure in the cylinder, a volume of the cylinder, and a temperature of air in the cylinder using the physics-based model.

16. The method of claim 15 further comprising estimating the pressure in the cylinder and the temperature of air in the cylinder based on an intake air temperature, an intake manifold pressure, an exhaust gas temperature, an exhaust gas pressure, and engine speed.

17. The method of claim 16 further comprising determining the error magnitude based on an intake cam phaser position and an exhaust cam phaser position using the experimental model.

18. The method of claim 17 further comprising determining the error magnitude further based on the intake manifold pressure and the engine speed using the experimental model.

19. The method of claim 14 further comprising:
estimating the torque output of the engine based on the estimated amount of air in the cylinder as adjusted; and
controlling the engine actuator based on the estimated torque output.

20. The method of claim 19 further comprising:
determining a torque request based on the estimated torque output and a driver torque request; and
controlling the engine actuator based on the torque request.
